(19) United States
(12) Patent Application Publication
(10) Pub. No.: US 2019/0313474 A1
(43) Pub. Date: Oct. 10, 2019

(54) REDUNDANCY OFFSETS FOR DISCONTINUOUS COMMUNICATIONS

(71) Applicant: QUALCOMM Incorporated, San Diego, CA (US)

(72) Inventors: Manjunatha Kantharaju, Bangalore (IN); Shankar Ganesh Lakshmanaswamy, Bangalore (IN); Vaishali Ailani Rai, Bangalore (IN); Min Wang, San Diego, CA (US)

(21) Appl. No.: 15/946,306

(22) Filed: Apr. 5, 2018

(51) Int. Cl. H04W 76/28; H04W 52/02

(52) U.S. Cl. CPC H04W 76/28; H04L 65/608; H04W 52/0216

(57) ABSTRACT

Methods, systems, and devices for wireless communications are described. A device may identify a cycle length associated with a discontinuous communication mode, determine a frame duration associated with the discontinuous communication mode, select a redundancy offset that is greater than or equal to the cycle length, and communicate with a second device in the discontinuous communication mode using the redundancy offset. The device may generate a first frame that includes a set of data and a second frame that includes at least a subset of the set of data and may transmit the first frame at a first time and the second frame at a second time that is separated from the first time at least by the redundancy offset. A device may receive a first frame at a first time and a second frame at a second time that is separated from the first time by the redundancy offset.

### BACKGROUND

The following relates generally to wireless communication, and more specifically to redundancy offsets for discontinuous communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-s-OFDM). A wireless multiple-access communications system may include a number of base stations or network access nodes, each simultaneously supporting communication for multiple communication devices, which may be otherwise known as user equipment (UE).

Some wireless devices may operate in a discontinuous communication mode at least some of the time. Such a discontinuous communication mode may allow the device to conserve power, may free up wireless resources for other devices, or may provide other such benefits to a wireless system. In a discontinuous communication mode, a wireless device may alternate between periods of active communication and periods of little or no communication (e.g., sleep periods). The ratio of time spent actively communicating to that spent in a sleep mode may be adjusted (e.g., dynamically) and may influence (e.g., or be influenced by) power consumption at the device.

### SUMMARY

The described techniques relate to improved methods, systems, devices, or apparatuses that support redundancy offsets for discontinuous communications. Generally, the described techniques provide for selection of redundancy offset(s) for discontinuous communications which reduce the chance of losing (e.g., unsuccessfully decoding) a given packet. In accordance with the described techniques, a wireless device (e.g., a transmitter and/or a receiver) may determine the redundancy offset based on one or more factors, including a frame duration, a cycle length of the discontinuous communication mode, a signal quality, etc. By including these factors in the selection of the redundancy offset, communicating devices may in some cases reduce the amount of time required to reach a suitable redundancy offset (e.g., which may otherwise be selected based exclusively on analysis of channel state information). The wireless device may in some cases select a redundancy offset that is greater than or equal to the cycle length, which may allow the redundant transmission to be sent under different channel conditions from the original transmission). In some cases, the redundancy offset may be negotiated by communicating devices (e.g., one device may indicate a preferred redundancy offset to the other device).

A method of wireless communication is described. The method may include identifying a cycle length associated with a discontinuous communication mode, determining a frame duration associated with the discontinuous communication mode, selecting a redundancy offset that is greater than or equal to the cycle length based at least in part on the cycle length and the frame duration, and communicating with a second device in the discontinuous communication mode using the redundancy offset.

Another apparatus for wireless communication is described. The apparatus may include a processor, memory in electronic communication with the processor, and instructions stored in the memory. The instructions may be operable to cause the processor to identify a cycle length associated with a discontinuous communication mode, determine a frame duration associated with the discontinuous communication mode, select a redundancy offset that is greater than or equal to the cycle length based at least in part on the cycle length and the frame duration, and communicate with a second device in the discontinuous communication mode using the redundancy offset.

A non-transitory computer-readable medium for wireless communication is described. The non-transitory computer-readable medium may include instructions operable to cause a processor to identify a cycle length associated with a discontinuous communication mode, determine a frame duration associated with the discontinuous communication mode, select a redundancy offset that is greater than or equal to the cycle length based at least in part on the cycle length and the frame duration, and communicate with a second device in the discontinuous communication mode using the redundancy offset.

Some examples of the method, apparatus, and non-transitory computer-readable medium described above may further include processes, features, means, or instructions for generating a first frame that includes a set of data. Some examples of the method, apparatus, and non-transitory computer-readable medium described above may further include processes, features, means, or instructions for generating a second frame that includes at least a subset of the set of data, wherein communicating with the second device comprises transmitting, to the second device, the first frame at a first time and the second frame at a second time that may be separated from the first time by the redundancy offset.

In some examples of the method, apparatus, and non-transitory computer-readable medium described above, communicating with the second device comprises receiving, from the second device, a first frame at a first time and a second frame at a second time that may be separated from the first time by the redundancy offset. Some examples of the method, apparatus, and non-transitory computer-readable medium described above may further include processes, features, means, or instructions for decoding a set of data based at least in part on receiving the first frame, the second frame, or both.

Some examples of the method, apparatus, and non-transitory computer-readable medium described above may further include processes, features, means, or instructions for transmitting an indication of the redundancy offset to the second device, wherein communicating with the second device in the discontinuous communication mode using the redundancy offset may be based at least in part on transmitting the indication of the redundancy offset to the second device.

In some examples of the method, apparatus, and non-transitory computer-readable medium described above, transmitting the indication of the redundancy offset comprises transmitting the indication of the redundancy offset using a Real-Time Transmission Protocol (RTP) packet or a Real-Time Control Protocol (RTCP) packet.

Some examples of the method, apparatus, and non-transitory computer-readable medium described above may further include processes, features, means, or instructions for receiving an indication of a candidate redundancy offset from the second device, wherein selecting the redundancy offset may be based at least in part on receiving the indication of the candidate redundancy offset.

Some examples of the method, apparatus, and non-transitory computer-readable medium described above may further include processes, features, means, or instructions for identifying a signal quality metric for communications with the second device, wherein selecting the redundancy offset may be based at least in part on the signal quality metric.

In some examples of the method, apparatus, and non-transitory computer-readable medium described above, the cycle length may be an integer multiple of the frame duration.

In some examples of the method, apparatus, and non-transitory computer-readable medium described above, the redundancy offset comprises a total duration of a number of frames between a first frame comprising a set of data and a second frame comprising at least a subset of the set of data.

In some examples of the method, apparatus, and non-transitory computer-readable medium described above, the number of frames may be greater than or equal to a ratio of the cycle length to the frame duration.

### BRIEF DESCRIPTION OF THE DRAWINGS

FIG. 1 illustrates an example of a wireless communications system that supports redundancy offsets for discontinuous communications in accordance with aspects of the present disclosure.

FIG. 2 illustrates an example of a wireless communications system that supports redundancy offsets for discontinuous communications in accordance with aspects of the present disclosure.

FIG. 3 illustrates an example of a timing diagram that supports redundancy offsets for discontinuous communications in accordance with aspects of the present disclosure.

FIG. 4 illustrates an example of a process flow that supports redundancy offsets for discontinuous communications in accordance with aspects of the present disclosure.

FIG. 5 shows a block diagram of a device that supports redundancy offsets for discontinuous communications in accordance with aspects of the present disclosure.

FIG. 6 illustrates a block diagram of a system including a wireless device that supports redundancy offsets for discontinuous communications in accordance with aspects of the present disclosure.

FIGS. 7 through 9 illustrate methods for redundancy offsets for discontinuous communications in accordance with aspects of the present disclosure.

### DETAILED DESCRIPTION

Some wireless systems may utilize discontinuous communications in which packets are transmitted or received during intervals that occur with a given periodicity (e.g., which may be updated dynamically). For example, during a Voice over LTE (VoLTE) call, when Connected Mode Discontinuous Reception (CDRX) is enabled, packets may arrive at a user equipment (UE) according to a CDRX cycle (e.g., which may have a duration of 20 ms, 40 ms, 60 ms). VoLTE calls may in some cases be enabled with redundancy technology that carries a redundant copy of the current frame along with an initial copy of a future frame.

Additionally or alternatively, some wireless communications may benefit from transmission of at least some redundant or similar information, which may improve communication reliability, range, security, etc. Redundant transmissions may leverage channel diversity (e.g., differences in channel conditions at various times) to improve the chances of receiving given communication information (e.g., data). Because discontinuous communication may restrict the available transmission times (and, in some cases, the available channel diversity), improved redundancy offsets for discontinuous communications may be desired.

The redundancy operation may support transmission of a full or partial copy of the current frame along with the future frame. The redundancy operation may operate with the hope that in the event of the loss of the current frame (e.g., because of interference, network latency), the redundant copy from the future frame may be decoded and used to replace at least part of the data from the lost packet (e.g., without significantly deteriorating communication quality).

For example, the partial redundant copy may be generated by the encoder of a transmitting device and understood by the decoder of a receiving device (e.g., according to some defined or negotiated encoding scheme). Alternatively, a full redundant copy may be generated at the packaging process by a transmitter and may be expected by a decoder of a receiving device. For example, the packaging process at the encoder may be responsible for packing a voice frame into an internet protocol (IP) packet (e.g., and unpacking the voice frame from the IP packet at the decoder). In some cases, the packaging process may be configured with a redundancy offset in accordance with various aspects. The redundancy offset may determine the latency (e.g., time offset, duration) between the initial copy of a packet in a current frame and a redundant copy of the packet (e.g., or a portion thereof) in a future frame. In some cases, the redundancy offset may be configured in terms of a number of frames.

Some examples of considerations for selecting a suitable redundancy offset are discussed below. One such consideration includes selecting the redundancy offset such that the future frame with the redundant copy of the current frame falls within a different interval of the overall CDRX cycle from the current frame. The overall CDRX cycle may refer to a set of periodically occurring transmission intervals (e.g., a set of 20 ms communication intervals which are separated in time by periods of inactivity). For example, each communication interval of the overall CDRX cycle may contain a given set of transmissions (which may be referred to as frames herein). In cases in which the current and redundant copies of a given frame are transmitted across a lossy channel (e.g., a medium over which transmissions may be corrupted because of interference, physical obstacles) during the same transmission interval of the overall CDRX cycle, both the current frame carrying a first copy of information and the future frame carrying a redundant copy of information may be lost. By selecting a redundancy offset in accordance with aspects of the present disclosure, the efficacy of the redundancy may be improved.

Aspects of the disclosure are initially described in the context of a wireless communications system. Aspects of the disclosure are then illustrated in the context of timing diagrams and a process flow. Aspects of the disclosure are further illustrated by and described with reference to apparatus diagrams, system diagrams, and flowcharts that relate to redundancy offsets for discontinuous communications.

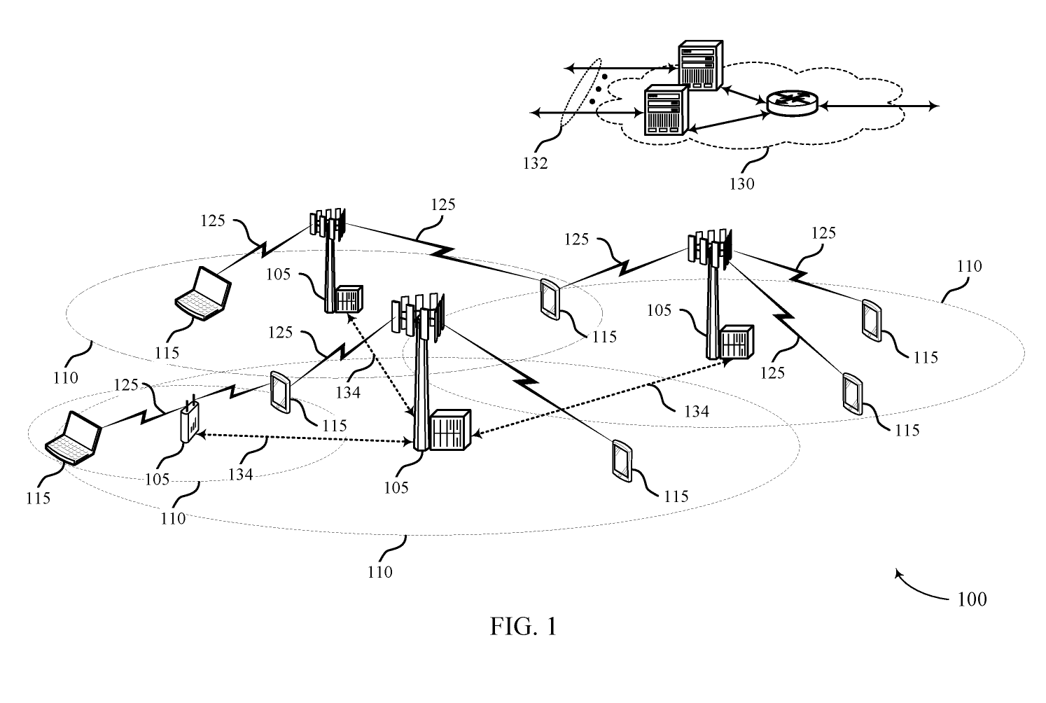

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 are supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115).

In some examples, the beam direction associated with transmissions along a single beam direction may be determined based at least in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

In some cases, wireless communications system 100 may be a packet-based network that operates according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

In accordance with aspects of the present disclosure, a device such as a UE 115 or a base station 105 may identify a cycle length associated with a discontinuous communication mode (e.g., a CDRX cycle). The device may determine a frame duration associated with the discontinuous communication mode. The device may select a redundancy offset between different transmissions of certain information that is greater than or equal to the cycle length. The device may then communicate with a second device in the discontinuous communication mode using the redundancy offset. For example, the device may generate a first frame that includes a set of information (e.g., data) and a second frame that includes at least a subset of the set of information (e.g., data) and may transmit the first frame to the second device at a first time and the second frame to the second device at a second time that is separated from the first time by the redundancy offset. Additionally or alternatively, the device may receive a first frame that includes a set of information (e.g., data) at a first time and a second frame that includes at least a subset of the set of information (e.g., data) at a second time that is separated from the first time by the redundancy offset.

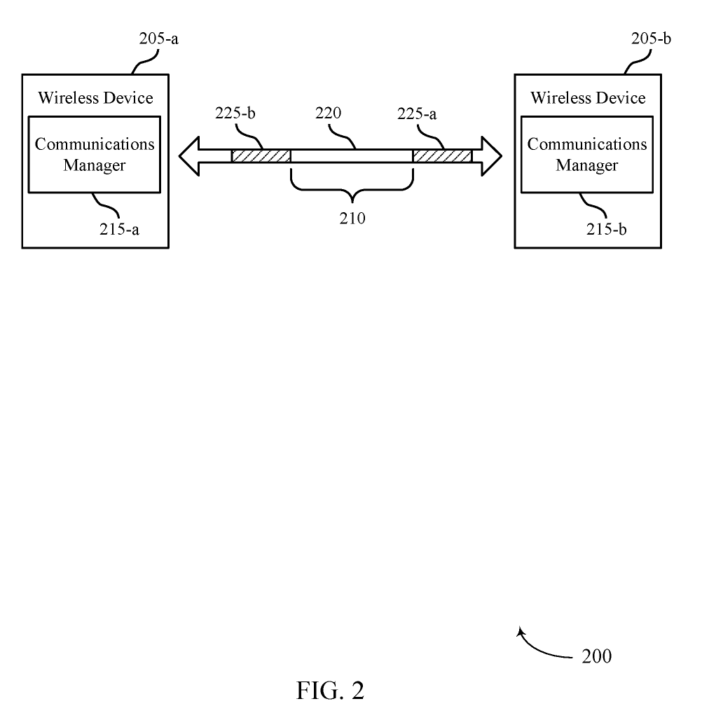

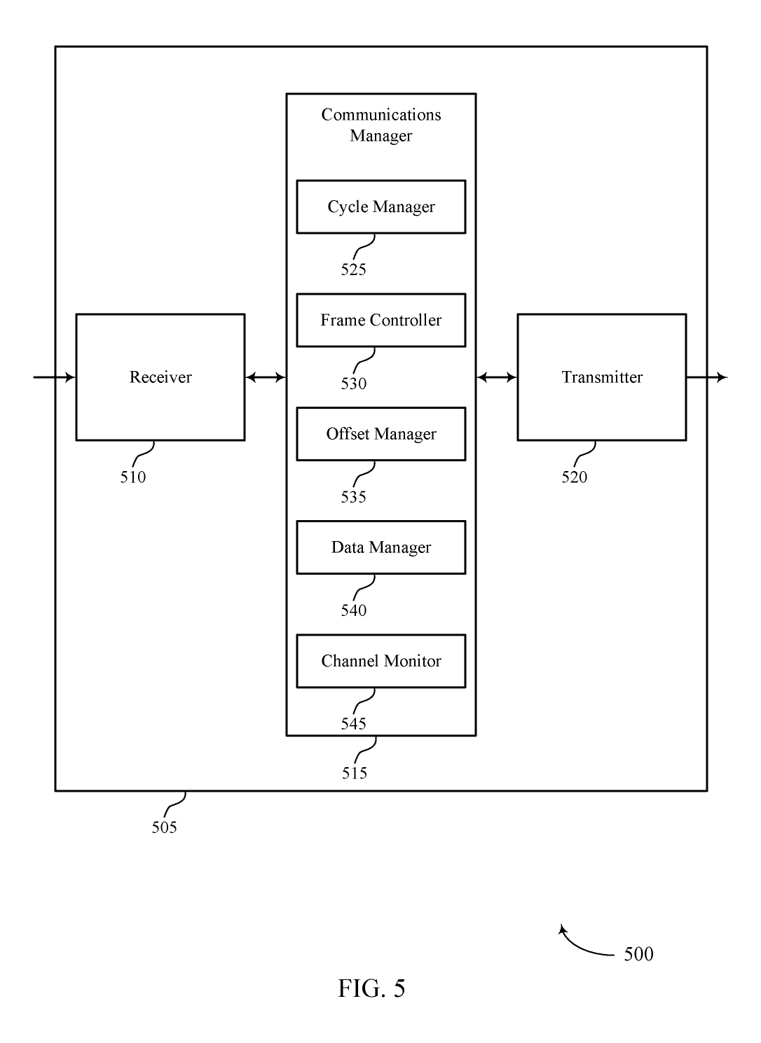

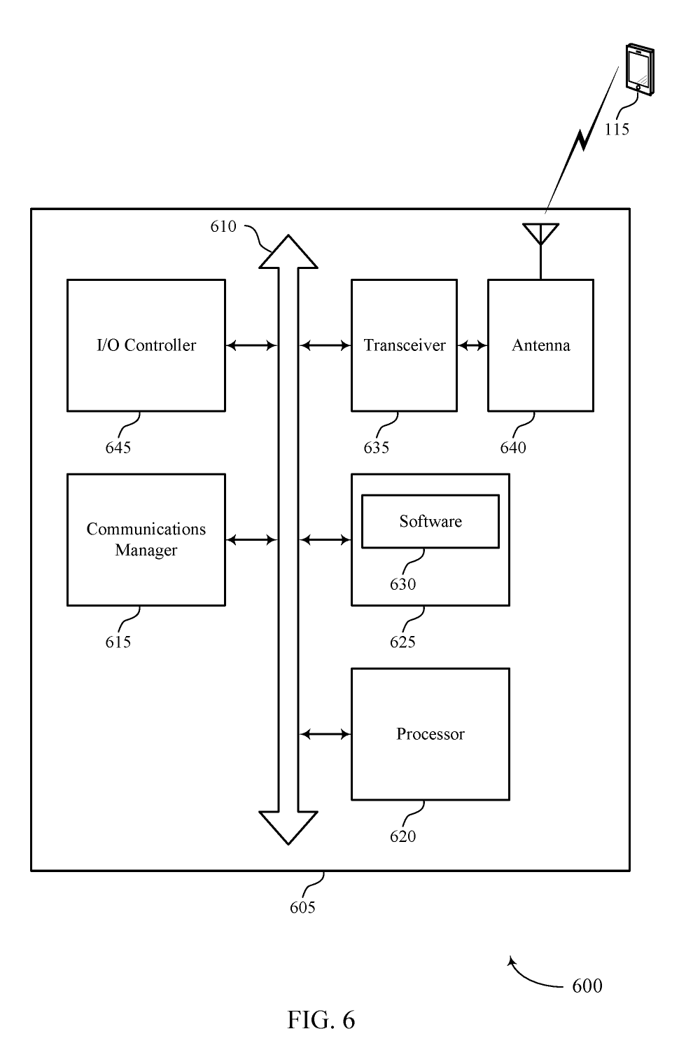

FIG. 2 illustrates an example of a wireless communications system 200 that supports redundancy offsets for discontinuous communications in accordance with various aspects of the present disclosure. In some examples, wireless communications system 200 may implement aspects of wireless communication system 100. Wireless communications system 200 includes wireless device 205-a and wireless device 205-b, each of which may be an example of a UE 115 or a base station 105 as described with reference to FIG. 1. Wireless device 205-a includes communications manager 215-a, and wireless device 205-b includes communications manager 215-b. Each communications manager 215 may be an example of (e.g., or perform operations of) the corresponding component described with reference to FIGS. 5 and 6.

Wireless device 205-a and wireless device 205-b may be operable to communicate via wireless link 220. For example, wireless link 220 may support uplink communications, downlink communications, sidelink communications, and the like. In aspects of the following, wireless device 205-a may be referred to as a transmitter while wireless device 205-b may be referred to as a receiver. In other examples, the roles may be reversed (e.g., such that wireless device 205-a may be a transmitter in some instances and a receiver in others).

Wireless device 205-a may transmit frame 225-a over link 220 at a first point in time and may transmit frame 225-b over link 220 at a second point in time (e.g., which is separated from the first point in time by offset 210). For example, frame 225-a may be or contain an initial representation of a set of data while frame 225-b provides (at least partial) redundancy to frame 225-a. That is, frame 225-b may contain a complete copy of the set of data from frame 225-a or a portion thereof.

In some cases, wireless device 205-a and wireless device 205-b may communicate in a discontinuous communication mode. For example, one or both wireless devices 205 may be an example of a power-limited (e.g., or low-throughput) device. Though aspects of the following are described with wireless device 205-b (e.g., the receiver) operating in the discontinuous communication mode (e.g., alternating between active communication and dormant periods), it is to be understood that in some cases wireless device 205-a (e.g., the transmitter) may additionally or alternatively be the device operating in the discontinuous communication mode.

Considerations for a duration of offset 210 are discussed herein. For example, if offset 210 is below a certain length, frame 225-a and frame 225-b may be contained in a same cycle of the discontinuous communication mode (e.g., a same active communication period). In some such cases, the redundancy (e.g., the inclusion of at least some information that is redundant to at least some information included in another frame such as frame 225-a) provided by frame 225-b may be lost because link 220 suffers degraded communication quality (e.g., because of interference from other signals, physical obstacles, beam-loss) for some or all of the active communication period.

In accordance with the described techniques, one or both wireless devices 205 may determine or select a redundancy offset 210 that provides suitable channel diversity for frame 225-a and frame 225-b. For example, the redundancy offset 210 may be selected such that frame 225-a falls in a first group of frames (e.g., a first active communication period of wireless device 205-b) and frame 225-b falls in a second group of frames (e.g., a subsequent active communication period of wireless device 205-b).

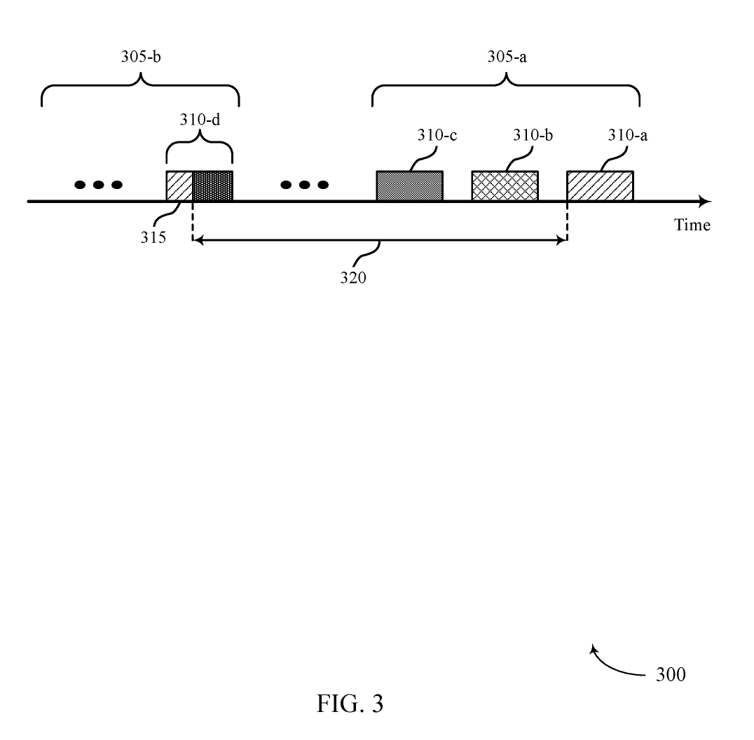

FIG. 3 illustrates an example of a timing diagram 300 that supports redundancy offsets for discontinuous communications in accordance with various aspects of the present disclosure. In some examples, timing diagram 300 may implement aspects of wireless communication system 100. For example, timing diagram 300 may illustrate aspects of communication between two wireless devices as described with reference to FIGS. 1 and 2.

Timing diagram 300 includes multiple frames 310 separated into cycles 305. For example, each cycle 305 may represent a respective active communication period during a discontinuous communication cycle for a given wireless device. That is, a wireless device may actively communicate (e.g., transmit and/or receive frames 310) during cycle 305-a before entering a dormant mode for some duration of time and then resuming active communications during cycle 305-b. In some examples, cycle 305-a and cycle 305-b may have a same or different length (e.g., 20 ms, 40 ms, 60 ms). Similarly, each frame 310 may have a same or different frame duration (e.g., 5 ms, 10 ms, 20 ms, 240 ms). In some cases, the length of a given cycle 305 may be an integer multiple of the duration of one or more frames 310.

During cycle 305-a, two or more wireless devices may communicate frames 310-a, 310-b, and 310-c. Each frame 310 may contain one or more audio frames (or packets). In accordance with the described techniques, the wireless devices may select redundancy offset 320 based on one or more factors including a duration of frames 310, a length of cycle 305-a, and/or a signal quality metric for communications between the wireless devices. For example, redundancy offset 320 may be selected such that redundant information 315 is transmitted in frame 310-d (e.g., which occurs during cycle 305-b). Redundant information 315 may represent one or more complete audio frames (e.g., or portions thereof) initially included in frame 310-a. Thus, redundant information 315 may occupy at least a subset of the duration of frame 310-d (e.g., and/or a subset of the frequency range associated with frame 310-d).

In some cases, redundancy offset 320 may be expressed as a number of frames 310 (e.g., a number of frames between frames that contain at least a subset of similar or the same data) and may be selected to be greater than or equal to a ratio of the length of cycle 305-a to the duration of one or more frames 310. That is, in the case that cycle 305-a has a length of 60 ms and each of frames 310-a, 310-b, and 310-c has a duration of 20 ms, redundancy offset 320 may be greater than or equal to three frames (e.g., be greater than or equal to 60 ms). By selecting redundancy offset 320 such that redundant information 325 occurs in a different cycle 305 from the initial transmission (e.g., frame 310-a), the efficacy of the redundancy may be improved, providing distinct advantages for a wireless system.

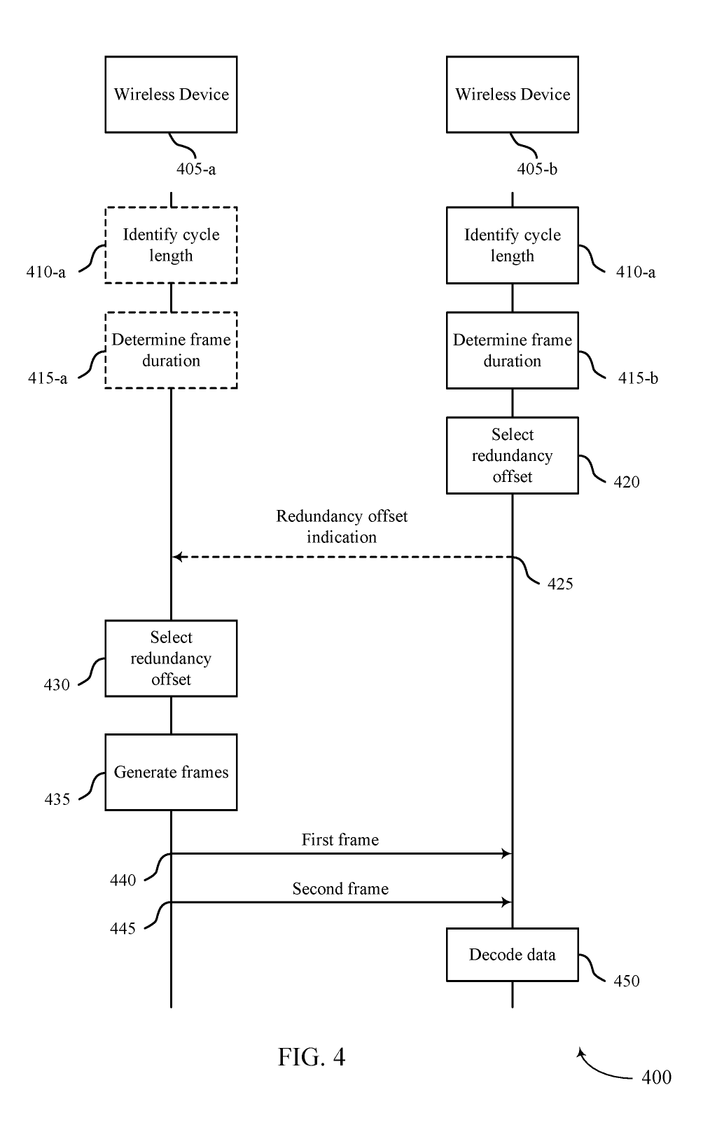

FIG. 4 illustrates an example of a process flow 400 that supports redundancy offsets for discontinuous communications in accordance with various aspects of the present disclosure. In some examples, process flow 400 may implement aspects of wireless communication system 100. For example, process flow 400 includes wireless device 405-a and wireless device 405-b, each of which may be an example of a UE 115 or a base station 105 as described with reference to FIG. 1. In aspects of the following, wireless device 405-a may be referred to as a transmitting device while wireless device 405-b may be referred to as a receiving device.

As illustrated with respect to process flow 400, the redundancy offset used in aspects of the present disclosure may in some cases be determined at a receiving wireless device (e.g., wireless device 405-b) and communicated to a transmitting wireless device (e.g., wireless device 405-a). Additionally or alternatively, the redundancy offset may be determined in parallel at the two wireless devices 405 (e.g., based on some predefined or configurable rule).

At 410-b, wireless device 405-b may identify a cycle length associated with a discontinuous communication mode. In some cases, wireless device 405-a may additionally or alternatively identify the cycle length (e.g., at 410-a). Though illustrated as occurring simultaneously, it is to be understood that the operations at 410-a and 410-b may in some cases be performed in parallel (e.g., independently at wireless device 405-a and wireless device 405-b) without necessarily occurring at the same time. As described with reference to cycles 305 of timing diagram 300, example cycle lengths include (but are not limited to) 20 ms, 60 ms, and 240 ms.

Similarly, at 415-b wireless device 405-b (may determine a frame duration associated with the discontinuous communication mode. In some cases, wireless device 405-a may additionally or alternatively determine the frame duration (e.g., at 415-a). Though illustrated as occurring simultaneously, it is to be understood that the operations at 415-a and 415-b may in some cases be performed in parallel (e.g., independently at wireless device 405-a and wireless device 405-b) without necessarily occurring at the same time. As described with reference to frames 310 of timing diagram 300, example frame durations include (but are not limited to) 5 ms, 20 ms, and 240 ms. In some cases, the cycle length may be an integer multiple of the frame duration.

At 420, wireless device 405-b may select a redundancy offset that is greater than or equal to the cycle length. In some cases, the redundancy offset may be or include a total duration of a number of frames between a first frame and a second frame, where the first frame and the second frame share at least some data (e.g., where the second frame provides redundancy for the first frame).

In some cases, this number of frames may be greater than or equal to a ratio of the cycle length to the frame duration. For example, if the cycle length is 240 ms and the frame duration is 20 ms, the number of frames may be greater than or equal to twelve. In some cases, one or more additional factors may influence the selected redundancy offset. For example, the redundancy offset may in some cases depend on a signal quality metric for communications between wireless device 405-a and wireless device 405-b. As an example, the redundancy offset may be inversely proportional to the signal quality metric (e.g., such that the redundancy offset is reduced when the signal quality is high). Additionally or alternatively, the redundancy offset may be based on a consistency of the signal quality metric over time. That is, the redundancy offset may increase when the signal quality is relatively constant over time. Other such considerations may be included.

In some cases, wireless device 405-b may transmit an indication of the redundancy offset to wireless device 405-a. For example, the indication may be carried (e.g., in a Codec Mode Request (CMR)) in a Real-Time Transmission Protocol (RTP) packet or a Real-Time Control Protocol (RTCP) packet.

At 430, wireless device 405-a may select a redundancy offset (e.g., the same redundancy offset as that selected by wireless device 405-b at 420). In some cases, the redundancy offset selected by wireless device 405-a at 430 may be based on the cycle length and frame duration determined at 410 and 415, respectively. Thus, in some cases the operations at 430 may be performed by wireless device 405-a in parallel with those performed by wireless device 405-b at 420. Additionally or alternatively, the redundancy offset selected by wireless device 405-a at 430 may be based on the indication received from wireless device 405-b at 425.

At 435, wireless device 405-a may generate a first frame that includes a set of data (e.g., an audio packet) and a second frame that includes at least a subset of the set of data (e.g., the audio packet or a portion thereof). Wireless device 405-a may transmit the first frame at 440 and may transmit the second frame at 445. In accordance with the present disclosure, the transmissions at 440 and 445 may be separated (in time) by the redundancy offset selected at 420 and/or 430.

At 450, wireless device 405-b may decode the set of data (e.g., the audio packet) based at least in part on receiving the first frame at 440, the second frame at 445, or both. For example, wireless device 405-a may in some cases transmit the first frame at 440 and the second frame with the redundant information at 445 regardless of whether the first frame is successfully received (e.g., because of a lack of acknowledgement capabilities of wireless device 405-b). Thus, in some cases wireless device 405-b may successfully decode the audio packet based only on the first frame. Alternatively, wireless device 405-b may combine decoded information for the first frame with decoded information for the second frame to decode the data (e.g., the audio packet).

Thus, the present disclosure generally relates to improved redundancy offsets for discontinuous communications. The described techniques may allow communicating devices to quickly determine (e.g., or negotiate) a suitable redundancy offset. For example, two wireless devices in communication may determine an initial redundancy offset hypothesis using aspects of the present disclosure. Each wireless device may independently determine the initial redundancy offset hypothesis (e.g., based on some agreed-upon or pre-configured rule) or one wireless device may determine the initial redundancy offset hypothesis and communicate an indication of the hypothesis to the other wireless device.

After determining an initial redundancy offset hypothesis, the communicating devices may in some cases adjust the hypothesis (e.g., based on channel state information, block error rates, or other such feedback). Determining an initial redundancy offset hypothesis based on a frame duration and cycle length may reduce the search time required for communicating devices to find a suitable redundancy offset (e.g., compared to redundancy offset algorithms which are based primarily or exclusively on channel state feedback). That is, because communicating channel state feedback may introduce latency (e.g., because the feedback requires time to be prepared, communicated, and deciphered), redundancy offset algorithms based only on channel state feedback may involve lengthy or otherwise computationally intensive search processes.

Additional factors that may influence the redundancy offset include (but are not limited to) an amount of data to be communicated, a power level of one or both communicating devices, and a type of data being communicated (e.g., latency-sensitive data compared to best effort data). By way of example, the redundancy offset may be increased when there is a relatively small amount of data to be communicated or the data is not latency-sensitive. Similarly, the redundancy offset may be adjusted (increased or decreased) based on a power level or processing capability of one or both communicating devices.

FIG. 5 shows a block diagram 500 of a wireless device 505 that supports redundancy offsets for discontinuous communications in accordance with aspects of the present disclosure. Wireless device 505 may be an example of aspects of a UE 115 or a base station 105 as described herein. Wireless device 505 may include receiver 510, communications manager 515, and transmitter 520. Wireless device 505 may also include a processor. Communications manager 515 may also include cycle manager 525, frame controller 530, offset manager 535, data manager 540, and channel monitor 545. Each of these components may be in communication with one another (e.g., via one or more buses).

Receiver 510 may receive information such as packets, user data, or control information associated with various information channels (e.g., control channels, data channels, and information related to redundancy offsets for discontinuous communications). Information may be passed on to other components of the device. The receiver 510 may be an example of aspects of the transceiver 635 described with reference to FIG. 6. The receiver 510 may utilize a single antenna or a set of antennas.

Communications manager 515 may be an example of aspects of the communications manager 615 described with reference to FIG. 6. Communications manager 515 and/or at least some of its various sub-components may be implemented in hardware, software executed by a processor, firmware, or any combination thereof. If implemented in software executed by a processor, the functions of the communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 515 and/or at least some of its various sub-components may be physically located at various positions, including being distributed such that portions of functions are implemented at different physical locations by one or more physical devices. In some examples, communications manager 515 and/or at least some of its various sub-components may be a separate and distinct component in accordance with various aspects of the present disclosure. In other examples, communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Cycle manager 525 may identify a cycle length associated with a discontinuous communication mode. In some cases, the cycle length may be an integer multiple of the frame duration associated with the discontinuous communication mode. The cycle length may refer to a duration of time during which wireless device 505 is actively transmitting and/or receiving data. Alternatively, the cycle length may refer to an amount of time between a first such active communication period and an immediately subsequent communication period. Example cycle lengths include (but are not limited to) 20 ms, 40 ms, and 60 ms.

Frame controller 530 may determine a frame duration associated with the discontinuous communication mode. Example frame durations include (but are not limited to) 5 ms, 10 ms, and 20 ms. In some cases, the frame duration is less than (or equal to) the cycle length.

Offset manager 535 may select a redundancy offset that is greater than or equal to the cycle length based on the cycle length and the frame duration. Offset manager 535 may in some cases transmit an indication of the redundancy offset to a second device. In some cases, transmitting the indication of the redundancy offset includes transmitting the indication of the redundancy offset using a RTP packet or a RTCP packet. Additionally or alternatively, offset manager 535 may receive an indication of a candidate redundancy offset from the second device, where selecting the redundancy offset is based on receiving the indication of the candidate redundancy offset. In some cases, the redundancy offset includes a total duration of a number of frames between a first frame including a set of data and a second frame including at least a subset of the set of data. In some cases, the number of frames is greater than or equal to a ratio of the cycle length to the frame duration.

Data manager 540 may communicate with a second device in the discontinuous communication mode using the redundancy offset. For example, data manager 540 may generate a first frame that includes a set of data and a second frame that includes at least a subset of the set of data, where communicating with the second device includes transmitting, to the second device, the first frame at a first time and the second frame at a second time that is separated from the first time by the redundancy offset. Additionally or alternatively, data manager 540 may receive, from the second device, a first frame at a first time and a second frame at a second time that is separated from the first time by the redundancy offset. In some such cases, data manager 540 may decode a set of data based on receiving the first frame, the second frame, or both.

Channel monitor 545 may identify a signal quality metric for communications with the second device, where selecting the redundancy offset is based on the signal quality metric. For example, the redundancy offset may be inversely (e.g., or directly) proportional to the signal quality metric. That is, in some examples, the redundancy offset may decrease as the signal quality metric increases. In some cases, the redundancy offset and the signal quality metric may be related through a look-up table (e.g., where a given range of signal qualities are associated with a given redundancy offset). Additionally or alternatively, the signal quality metric may factor into a redundancy offset determination (e.g., either quantitatively or qualitatively).

Transmitter 520 may transmit signals generated by other components of the device. In some examples, the transmitter 520 may be collocated with a receiver 510 in a transceiver module. For example, the transmitter 520 may be an example of aspects of the transceiver 635 described with reference to FIG. 6. The transmitter 520 may utilize a single antenna or a set of antennas.

FIG. 6 shows a diagram of a system 600 including a device 605 that supports redundancy offsets for discontinuous communications in accordance with aspects of the present disclosure. Device 605 may be an example of or include the components of wireless device, a UE 115, or a base station 105 as described above, e.g., with reference to FIGS. 1, 2, 4, and 5. Device 605 may include components for bi-directional voice and data communications including components for transmitting and receiving communications, including communications manager 615, processor 620, memory 625, software 630, transceiver 635, antenna 640, and I/O controller 645. These components may be in electronic communication via one or more buses (e.g., bus 610).

Processor 620 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 620 may be configured to operate a memory array using a memory controller. In other cases, a memory controller may be integrated into processor 620. Processor 620 may be configured to execute computer-readable instructions stored in a memory to perform various functions (e.g., functions or tasks supporting redundancy offsets for discontinuous communications).

Memory 625 may include random access memory (RAM) and read only memory (ROM). The memory 625 may store computer-readable, computer-executable software 630 including instructions that, when executed, cause the processor to perform various functions described herein. In some cases, the memory 625 may contain, among other things, a basic input/output system (BIOS) which may control basic hardware or software operation such as the interaction with peripheral components or devices.

Software 630 may include code to implement aspects of the present disclosure, including code to support redundancy offsets for discontinuous communications. Software 630 may be stored in a non-transitory computer-readable medium such as system memory or other memory. In some cases, the software 630 may not be directly executable by the processor but may cause a computer (e.g., when compiled and executed) to perform functions described herein.

Transceiver 635 may communicate bi-directionally, via one or more antennas, wired, or wireless links as described above. For example, the transceiver 635 may represent a wireless transceiver and may communicate bi-directionally with another wireless transceiver. The transceiver 635 may also include a modem to modulate the packets and provide the modulated packets to the antennas for transmission, and to demodulate packets received from the antennas. In some cases, the wireless device may include a single antenna 640. However, in some cases the device may have more than one antenna 640, which may be capable of concurrently transmitting or receiving multiple wireless transmissions.

I/O controller 645 may manage input and output signals for device 605. I/O controller 645 may also manage peripherals not integrated into device 605. In some cases, I/O controller 645 may represent a physical connection or port to an external peripheral. In some cases, I/O controller 645 may utilize an operating system such as iOS®, ANDROID®, MS-DOS®, MS-WINDOWS®, OS/2®, UNIX®, LINUX®, or another known operating system. In other cases, I/O controller 645 may represent or interact with a modem, a keyboard, a mouse, a touchscreen, or a similar device. In some cases, I/O controller 645 may be implemented as part of a processor. In some cases, a user may interact with device 605 via I/O controller 645 or via hardware components controlled by I/O controller 645.

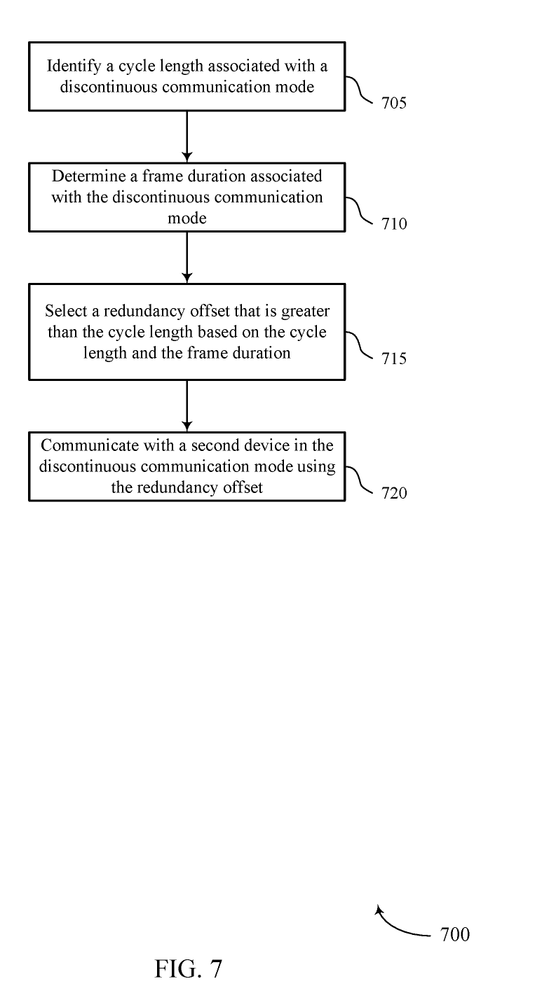

FIG. 7 shows a flowchart illustrating a method 700 for redundancy offsets for discontinuous communications in accordance with aspects of the present disclosure. The operations of method 700 may be implemented by a wireless device or its components as described herein. For example, the operations of method 700 may be performed by a communications manager as described with reference to FIGS. 5 and 6. In some examples, a wireless device may execute a set of codes to control the functional elements of the device to perform the functions described below. Additionally or alternatively, the wireless device may perform aspects of the functions described below using special-purpose hardware.

At 705 the wireless device may identify a cycle length associated with a discontinuous communication mode. The operations of 705 may be performed according to the methods described herein. In certain examples, aspects of the operations of 705 may be performed by a cycle manager as described with reference to FIGS. 5 and 6.

At 710 the wireless device may determine a frame duration associated with the discontinuous communication mode. The operations of 710 may be performed according to the methods described herein. In certain examples, aspects of the operations of 710 may be performed by a frame controller as described with reference to FIGS. 5 and 6.

At 715 the wireless device may select a redundancy offset that is greater than or equal to the cycle length based at least in part on the cycle length and the frame duration. The operations of 715 may be performed according to the methods described herein. In certain examples, aspects of the operations of 715 may be performed by a offset manager as described with reference to FIGS. 5 and 6.

At 720 the wireless device may communicate with a second device in the discontinuous communication mode using the redundancy offset. The operations of 720 may be performed according to the methods described herein. In certain examples, aspects of the operations of 720 may be performed by a data manager as described with reference to FIGS. 5 and 6.

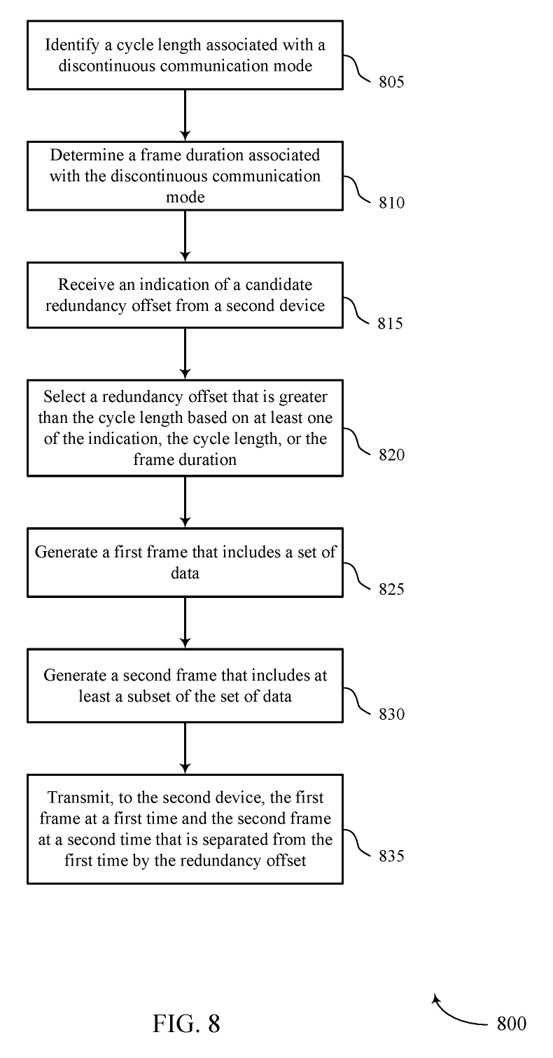

FIG. 8 shows a flowchart illustrating a method 800 for redundancy offsets for discontinuous communications in accordance with aspects of the present disclosure. The operations of method 800 may be implemented by a wireless device or its components as described herein. For example, the operations of method 800 may be performed by a communications manager as described with reference to FIGS. 5 and 6. In some examples, a wireless device may execute a set of codes to control the functional elements of the device to perform the functions described below. Additionally or alternatively, the wireless device may perform aspects of the functions described below using special-purpose hardware.

At 805 the wireless device may identify a cycle length associated with a discontinuous communication mode. The operations of 805 may be performed according to the methods described herein. In certain examples, aspects of the operations of 805 may be performed by a cycle manager as described with reference to FIGS. 5 and 6.

At 810 the wireless device may determine a frame duration associated with the discontinuous communication mode. The operations of 810 may be performed according to the methods described herein. In certain examples, aspects of the operations of 810 may be performed by a frame controller as described with reference to FIGS. 5 and 6.

At 815 the wireless device may receive an indication of a candidate redundancy offset from a second device. The operations of 815 may be performed according to the methods described herein. In certain examples, aspects of the operations of 815 may be performed by a offset manager as described with reference to FIGS. 5 and 6.

At 820 the wireless device may select a redundancy offset that is greater than or equal to the cycle length based on at least one of the indication, the cycle length, or the frame duration. The operations of 820 may be performed according to the methods described herein. In certain examples, aspects of the operations of 820 may be performed by a offset manager as described with reference to FIGS. 5 and 6.

At 825 the wireless device may generate a first frame that includes a set of data. The operations of 825 may be performed according to the methods described herein. In certain examples, aspects of the operations of 825 may be performed by a data manager as described with reference to FIGS. 5 and 6.

At 830 the wireless device may generate a second frame that includes at least a subset of the set of data. The operations of 830 may be performed according to the methods described herein. In certain examples, aspects of the operations of 830 may be performed by a data manager as described with reference to FIGS. 5 and 6.

At 835 the wireless device may transmit, to the second device, the first frame at a first time and the second frame at a second time that is separated from the first time by the redundancy offset. The operations of 835 may be performed according to the methods described herein. In certain examples, aspects of the operations of 835 may be performed by a data manager as described with reference to FIGS. 5 and 6.

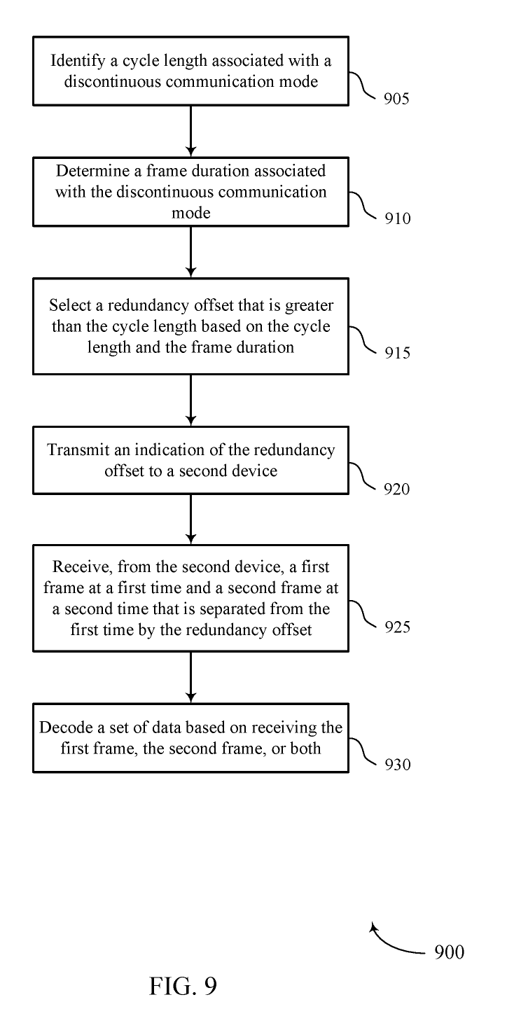

FIG. 9 shows a flowchart illustrating a method 900 for redundancy offsets for discontinuous communications in accordance with aspects of the present disclosure. The operations of method 900 may be implemented by a wireless device or its components as described herein. For example, the operations of method 900 may be performed by a communications manager as described with reference to FIGS. 5 and 6. In some examples, a wireless device may execute a set of codes to control the functional elements of the device to perform the functions described below. Additionally or alternatively, the wireless device may perform aspects of the functions described below using special-purpose hardware.

At 905 the wireless device may identify a cycle length associated with a discontinuous communication mode. The operations of 905 may be performed according to the methods described herein. In certain examples, aspects of the operations of 905 may be performed by a cycle manager as described with reference to FIGS. 5 and 6.

At 910 the wireless device may determine a frame duration associated with the discontinuous communication mode. The operations of 910 may be performed according to the methods described herein. In certain examples, aspects of the operations of 910 may be performed by a frame controller as described with reference to FIGS. 5 and 6.

At 915 the wireless device may select a redundancy offset that is greater than or equal to the cycle length based at least in part on the cycle length and the frame duration. The operations of 915 may be performed according to the methods described herein. In certain examples, aspects of the operations of 915 may be performed by a offset manager as described with reference to FIGS. 5 and 6.

At 920 the wireless device may transmit an indication of the redundancy offset to a second device. The operations of 920 may be performed according to the methods described herein. In certain examples, aspects of the operations of 920 may be performed by a offset manager as described with reference to FIGS. 5 and 6.

At 925 the wireless device may receive, from the second device, a first frame at a first time and a second frame at a second time that is separated from the first time by the redundancy offset. The operations of 925 may be performed according to the methods described herein. In certain examples, aspects of the operations of 925 may be performed by a data manager as described with reference to FIGS. 5 and 6.

At 930 the wireless device may decode a set of data based at least in part on receiving the first frame, the second frame, or both. The operations of 930 may be performed according to the methods described herein. In certain examples, aspects of the operations of 930 may be performed by a data manager as described with reference to FIGS. 5 and 6.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a device, comprising:
identifying a cycle length associated with a discontinuous communication mode;
determining a frame duration associated with the discontinuous communication mode;
selecting a redundancy offset that is greater than or equal to the cycle length based at least in part on the cycle length and the frame duration; and
communicating with a second device in the discontinuous communication mode using the redundancy offset.

2. The method of claim 1, further comprising:
generating a first frame that includes a set of data; and
generating a second frame that includes at least a subset of the set of data, wherein communicating with the second device comprises transmitting, to the second device, the first frame at a first time and the second frame at a second time that is separated from the first time by the redundancy offset.

3. The method of claim 1, wherein communicating with the second device comprises:
receiving, from the second device, a first frame at a first time and a second frame at a second time that is separated from the first time by the redundancy offset; and
decoding a set of data based at least in part on receiving the first frame, the second frame, or both.

4. The method of claim 3, further comprising:
transmitting an indication of the redundancy offset to the second device, wherein communicating with the second device in the discontinuous communication mode using the redundancy offset is based at least in part on transmitting the indication of the redundancy offset to the second device.

5. The method of claim 4, wherein transmitting the indication of the redundancy offset comprises:
transmitting the indication of the redundancy offset using a Real-Time Transmission Protocol (RTP) packet or a Real-Time Control Protocol (RTCP) packet.

6. The method of claim 1, further comprising:
receiving an indication of a candidate redundancy offset from the second device, wherein selecting the redundancy offset is based at least in part on receiving the indication of the candidate redundancy offset.

7. The method of claim 1, further comprising:
identifying a signal quality metric for communications with the second device, wherein selecting the redundancy offset is based at least in part on the signal quality metric.

8. The method of claim 1, wherein the cycle length is an integer multiple of the frame duration.

9. The method of claim 1, wherein the redundancy offset comprises a total duration of a number of frames between a first frame comprising a set of data and a second frame comprising at least a subset of the set of data.

10. The method of claim 9, wherein the number of frames is greater than or equal to a ratio of the cycle length to the frame duration.

11. An apparatus for wireless communication, comprising:
a processor;
memory in electronic communication with the processor; and
instructions stored in the memory and executable by the processor to cause the apparatus to:
identify a cycle length associated with a discontinuous communication mode;
determine a frame duration associated with the discontinuous communication mode;
select a redundancy offset that is greater than or equal to the cycle length based at least in part on the cycle length and the frame duration; and
communicate with a second device in the discontinuous communication mode using the redundancy offset.

12. The apparatus of claim 11, wherein the instructions are further executable by the processor to cause the apparatus to:
generate a first frame that includes a set of data; and
generate a second frame that includes at least a subset of the set of data, wherein communicating with the second device comprises transmitting, to the second device, the first frame at a first time and the second frame at a second time that is separated from the first time by the redundancy offset.

13. The apparatus of claim 11, wherein the instructions to communicate with the second device are executable by the processor to cause the apparatus to:
receive, from the second device, a first frame at a first time and a second frame at a second time that is separated from the first time by the redundancy offset; and
decode a set of data based at least in part on receiving the first frame, the second frame, or both.

14. The apparatus of claim 13, wherein the instructions are further executable by the processor to cause the apparatus to:
transmit an indication of the redundancy offset to the second device, wherein communicating with the second device in the discontinuous communication mode using the redundancy offset is based at least in part on transmitting the indication of the redundancy offset to the second device.

15. The apparatus of claim 14, wherein the instructions to transmit the indication of the redundancy offset are executable by the processor to cause the apparatus to:
transmit the indication of the redundancy offset using a Real-Time Transmission Protocol (RTP) packet or a Real-Time Control Protocol (RTCP) packet.

16. The apparatus of claim 11, wherein the instructions are further executable by the processor to cause the apparatus to:
receive an indication of a candidate redundancy offset from the second device, wherein selecting the redundancy offset is based at least in part on receiving the indication of the candidate redundancy offset.

17. The apparatus of claim 11, wherein the instructions are further executable by the processor to cause the apparatus to:
identify a signal quality metric for communications with the second device, wherein selecting the redundancy offset is based at least in part on the signal quality metric.

18. An apparatus for wireless communication, comprising:
means for identifying a cycle length associated with a discontinuous communication mode;
means for determining a frame duration associated with the discontinuous communication mode;
means for selecting a redundancy offset that is greater than or equal to the cycle length based at least in part on the cycle length and the frame duration; and
means for communicating with a second device in the discontinuous communication mode using the redundancy offset.

19. The apparatus of claim 18, further comprising:
means for generating a first frame that includes a set of data; and
means for generating a second frame that includes at least a subset of the set of data, wherein communicating with the second device comprises transmitting, to the second device, the first frame at a first time and the second frame at a second time that is separated from the first time by the redundancy offset.

20. The apparatus of claim 18, wherein the means for communicating with the second device comprises:
means for receiving, from the second device, a first frame at a first time and a second frame at a second time that is separated from the first time by the redundancy offset; and
means for decoding a set of data based at least in part on receiving the first frame, the second frame, or both.
